(19) United States
(12) Patent Application Publication
(10) Pub. No.: US 2014/0209820 A1
(43) Pub. Date: Jul. 31, 2014

(54) CONTOURED SUPPORT GRID FOR HERMETICALLY SEALED THIN FILM APPLICATIONS

(71) Applicants: Kenneth J. Barry, Dracut, MA (US); Mark T. Brown, Belmont, NH (US); Michael L. Bufano, Belmont, MA (US); Gerald M. Friedman, New Ipswich, NH (US); Peter M. King, Bedford, MA (US); Matthew A. Medford, Lynnfield, MA (US); Anne L. Testoni, Bolton, MA (US); Steven R. Walther, Andover, MA (US); Tzvi Avnery, Winchester, MA (US)

(72) Inventors: Kenneth J. Barry, Dracut, MA (US); Mark T. Brown, Belmont, NH (US); Michael L. Bufano, Belmont, MA (US); Gerald M. Friedman, New Ipswich, NH (US); Peter M. King, Bedford, MA (US); Matthew A. Medford, Lynnfield, MA (US); Anne L. Testoni, Bolton, MA (US); Steven R. Walther, Andover, MA (US); Tzvi Avnery, Winchester, MA (US)

(21) Appl. No.: 14/243,554

(22) Filed: Apr. 2, 2014

Related U.S. Application Data
(63) Continuation of application No. 13/881,969.
(60) Provisional application No. 61/407,090, filed on Oct. 27, 2010.

(51) Int. Cl. H01J 33/04; G21K 1/00

(52) U.S. Cl. CPC H01J 33/04; G21K 1/00
USPC 250/505.1; 156/64

(57) ABSTRACT

Systems and methods for manufacturing a vacuum device, such as an electron emitter, that includes a foil exit window palced over and joined to a support grid. In one particular method, the vacuum chamber of an electron emitter has a thin foil forming an exit window at one end. The thin foil may be titanium or any suitable material and the foil will typically enlarge during a bonding process that attaches the foil to the support grid. In one manufacturing process, the support grid is provided with a surface that has contours, typically being smooth recessed surfaces, that the foil once enlarged can lie against as the vacuum pulls the foil against the grid.

### REFERENCE TO RELATED APPLICATIONS

This application claims priority to U.S. Provisional Application 61/407090 filed 27 Oct. 2010, entitled Contoured Support Grid for Hermetically Sealed Thin Film Applications, the contents being incorporated by reference, and naming Kenneth J. Barry and others as inventors.

### FIELD OF THE INVENTION

The systems and methods described herein relate to vacuum devices such as electron emitters, and more particularly to electron emitters having a thin film over a support structure to provide an exit window.

### BACKGROUND OF THE INVENTION

Scientists and engineers working on vacuum devices have realized that vacuum exit windows for devices, including without limitation electron beam emitters and x-ray tubes, can be constructed by bonding or sealing a transmission layer, typically a thin foil of material, to a support grid structure. The transmission layer is of a material and thickness sufficient to serve as an airtight barrier that can adequately contain vacuum and to enable accelerated electrons generated in a vacuum to pass through the transmission layer into atmosphere with minimal energy loss in the layer. While the technical literature, such as U.S. Pat. No. 6,407,492, and PCT Publication W02010/104439, illustrate a broad range of potential materials and thicknesses, a typical transmission layer is comprised of 6-12 micron thick titanium or titanium bonded to other layers such as aluminum, silicon dioxide, or a variety of polymers. The support grid supports the film in such a way as to enable mechanical stability while minimizing obstruction of the accelerated electron beam that is transmitting through the vacuum window structure and providing efficient dissipation of heat loads. While the literature illustrates a wide range of potential materials and constructions for support grids, a typical support grid is comprised of copper or a copper alloy.

In constructing a vacuum chamber exit window, the transmission layer must be secured to the support grid so that a vacuum tight or hermetic seal is formed. The transmission layer may be secured to the support grid in many ways including without limitation mechanical techniques (e.g. clamping mechanism, wire seals) or metallurgical techniques (e.g. brazed, bonded, or welded). A method of securing a transmission layer to a support grid that has particular advantage is to create a diffusion bond between a transmission layer to form a hermetic (i.e. vacuum tight) seal.

During the diffusion bonding process the titanium foil can wrinkle and deform. The wrinkles become points of failure and this mechanical failure can take the form of splits or holes in the foil, and results in loss of vacuum, rendering the device inoperable. Mechanical failure results in loss of vacuum in the device, leaving it inoperable.

Accordingly, there is a need in the art for improved systems and methods for providing vacuum chambers sealed with a thin foil window.

### SUMMARY

The systems and methods described herein include, among other things, systems and methods for manufacturing an election emitter that includes a foil exit window placed over and joined to a support grid. More particularly, the systems and methods described herein, include, in one aspect, a method of manufacturing an emitter or any vacuum device, to have a foil exit window with reduced wrinkles during operation, and reduced metal fatigue arising from repeated formation of wrinkles in the foil caused by the repeated heating and cooling of the support grid and exit window which results from power-up and power-down cycles of normal operation,

In one particular method, the vacuum chamber of an election emitter has a thin foil forming an exit window at one end. The thin foil may be titanium or any suitable material. The foil is placed over and joined to a support plate. The support plate is typically a metal plate having apertures, such as an array of circular holes or a grid of square or rectangular openings. The foil lays over the grid and the grid provide mechanical support to the thin foil to reduce the likelihood that the vacuum will pull the thin foil into the chamber, with sufficient force to tear or rupture the foil. During the joining of the foil window to the support grid, the foil can thermally expand, and in-elastic or partially in elastic foils; will permanently, or at least for a substantial period of time, expand. The support grid, if elastic or at least more elastic than the foil, will expand and contract based on thermal conditions. In one manufacturing process, the support grid is provided a surface with contours, typically being smooth recessed surfaces, that the permanently expanded foil can lie against as the support grid contracts and the vacuum pulls the foil against the grid.

In one optimal practice, the support grid has contoured surfaces at the peripheral edge of the grid, proximate to the location of a bond between the foil and the grid. The contour may be a smooth recessed valley formed on the surface of the support grid, and placed proximate to the location of a bond between the foil and the grid, such that the contour is proximate the expected location of initial thermal expansion of the foil, and thus proximate.

An area more likely to be near the site of a wrinkle may occur but for the contour. Optionally and alternatively, contours may be formed across the entire surface, approximate the center, at the periphery, or a combination of these locations. In a further optional practice, the size and shape of the contour will be determined as a function of the expected in elastic expansion of the foil, which is one practice, may be determined as a function of lengths of the foil material and support material and the differences between the linear coefficients of thermal expansion for these two materials.

More particularly, the systems and methods described herein include an exit window for an emitter comprising, a support structure, such as a plate, grid, screen or other structure suitable for providing mechanical support to a foil, film or layer of material. The support plate has a series of apertures for allowing passage of a beam there through. The system also includes an exit window foil bonded over the support plate. The support plate has a planar surface and at least one surface recess which allows portions of the exit window foil to rest within the recess to reduce wrinkle formation. Optionally, the support plate has a first pattern of surface recesses, and in some embodiments the first pattern of surface recesses extend in a lateral direction relative to the support plate. Further optionally, the first pattern of surface recesses are in central regions of the support plate, and there may be a second pattern of surface recesses are in edge regions. In some embodiments the first pattern of surface recesses extends in a longitudinal direction relative to the support plate.

The surface recess may include at least one groove, and typically has an angle of incline set to provide a gradually recession into the support plate, thereby avoiding abrupt and changes to the surface of the recess. Further optionally, the recess may have a finish. The finish may be a mechanical polish, a brush finish, a plating, an electroplating, or a treatment such as galvanization. The finish may include a sealant or coating. Typically, the finish is selected to reduce the mechanical stress applied to the exit window foil as the emitter cycles through operations and thermal cycles.

In another aspect, the systems and methods described herein include processes for manufacturing a support plate for an exit window having a foil transmissive layer, comprising providing a support grid of a first material having a first coefficient of thermal expansion, providing a layer of transmissive material the layer having a length, a width and an initial surface area, covering the support grid to form a seal over the grid, the layer of transmissive material having a second different coefficient of thermal expansion, determining as a function of at least the first and second coefficients of thermal expansion, an expanded surface area represented of a surface area of the transmissive layer after a thermal expansion, and forming a contour is the support grid to provide the support grid with a surface area on its upper surface comparable to the expanded surface area.

Optionally, the processes further include the step of determining the expanded surface of the transmissive layer area as a function of thermal expansion arising from a thermal increased caused by a diffusion bonding operation, laser welding, chemical bonding, electron beam or x-ray bombardment or any process that may apply a thermal energy increase to the transmissive layer. The processes may place contours at the sites determined to be initiation sites, or may arrange the contours substantially evenly across an upper surface of the support grid to form a pattern, or may use a combination of the two.

Optionally, the processes may also include a step of locating an expansion initiation point on the layer of transmissive material representative of a location at which a thermal expansion process commences. The step of locating may include identifying a location proximate a boundary between a joint between the support grid and layer of transmissive material and a free section of the layer of transmissive material.

The processes may also selecting a surface finish for the contour. The finish may be applied to the entire support structure or to just the recessed surface of the contour may have a finish. The finish process may be a mechanical polish, a brush finishing, a plating, an electroplating, or a treatment such as galvanization. The finishing may include a sealing or coating the contour.

### BRIEF DESCRIPTION OF THE DRAWINGS

The systems and methods described herein are set forth in the appended claims. However, for purpose of explanation, several embodiments are set forth in the following figures,

FIGS. 1A-1C show an example vacuum window structure consisting of a support base and a support grid.

FIGS. 2A and B show a contour in the support grid upper surface;

FIG. 3 illustrates a support grid that includes edge contours consisting of small angled grooves and body contours in the form of wide grooves parallel to the short, axis of the support grid aligned with the mounting holes;

FIG. 4 illustrates a support grid that has multiple wide grooves oriented parallel to the short axis of the support grid;

FIG. 5 illustrates a support grid that has a body contour of a swept ellipsoid depression of varying depth;

FIG. 6 illustrates a support grid that has edge contours consisting of partial spheroids and body contours consisting of ellipsoid depressions oriented such that the short axis of the contour runs parallel to the long axis of the support grid.

FIG. 7 illustrates a support grid that has edge contours consisting of partial

spheroids and body contours consisting of ellipsoid depressions oriented such that, the short axis of the contour runs parallel to the short axis of the support grid.

FIG. 8 illustrates a support grid that has no edge contours and has body contours consisting of continuous grooves oriented in concentric rings.

FIG. 9 illustrates a support grid that has no edge contours and has body contours consisting of a single set of continuous grooves oriented in concentric rings with the long axis of the rings running parallel to the long axis of the support grid.

FIG. 10 illustrates a support grid that has no edge contours and has body contours consisting of multiple continuous grooves oriented with the long axis of the groove parallel to the short axis of the support grid.

FIG. 11 illustrates a support grid that has narrow grooves oriented parallel to the short axis of the support grid; and

FIG. 12 illustrates a support grid that has contours consisting of intersecting grooves running perpendicular to each other.

### DETAILED DESCRIPTION

In the following description, numerous details are set forth for purpose of explanation. However, one of ordinary skill in the art will realize that the embodiments described herein may be practiced without the use of these specific details,

In one embodiment, the systems and methods described herein include vacuum chamber systems that have thin exit windows, typically formed of a foil such as a titanium foil, and a support grid, typically formed of metal, although any suitable material may be used, that is positioned between the foil and a vacuum to provide the thin foil with mechanical support such that the foil does not tear or rupture as a result of the vacuum force that draws the foil into the chamber. In one embodiment, the systems and methods described herein include a support grid with an upper surface that has contoured recesses that are shaped and sized to provide a support surface that has sufficient surface area to provide support to the thin foil even after the thin foil has inelastically expanded due to, typically, thermal expansion of the foil. Optionally, the contours are located proximate the predicted initiation site of thermal expansion of the supporting grid and foil. This typically, although not always, is at a point on the grid proximate to a bonding point between the foil and the support grid surface.

Optionally and preferably, the contoured surface has a gradually changing surface depth such that the recess provides a smooth support surface for the thin film, and thereby avoids contacting the thin film with surface protrusions or ledges, or other surface features that create points of mechanical stress for the thin foil,

The systems and methods describe herein address the technical problem that in constructing a vacuum window, the transmission layer must be secured to the support grid so that a vacuum tight or hermetic seal is formed. The transmission layer may be secured to the support grid in many ways including without limitation mechanical techniques (e.g. clamping mechanism, wire seals) or metallurgical techniques (e.g. brazed, bonded, or welded). A method of securing a transmission layer to a support grid that has particular advantage is to create a diffusion bond between a transmission layer to form a hermetic (i.e. vacuum tight) seal,

It is common to use thin titanium foil as transmission layer and to use a base and support, grid structure constructed from copper. When using these materials, diffusion bonding is performed at temperatures greater than 350° C., typically greater than 400° C. These particular materials have different coefficients of thermal expansion (CTE).

During the diffusion bonding process the copper, or oilier support grid material, will expand more than the titanium foil, or other material used as the transmissive layer, when the bond temperature is reached. Because the titanium foil is pinned to the copper by a clamp, the titanium is forced to expand its area. The copper expansion is elastic, returning to its original shape and size when cooled. However, the titanium foil may be stretched such that tensile stress in the foil exceeds the yield strength of titanium, and the resulting deformation is inelastic. Therefore, when the combined structure is cooled to room temperature there is extra area of titanium foil that no longer conforms to the surface of the underlying copper structure.

This inelastic increase in surface area of the transmission layer demonstrates itself as wrinkles in the finished window structure where the transmission layer is bonded around the perimeter of the support grid. The wrinkles originate at the bond location and radiate out to the body of the copper grid structure. These wrinkles can be smooth in shape or they can form sharp ridges. The wrinkles can be straight or take bends in three dimensions. Sharp bent wrinkles have high mechanical stress.

During operation of the electron beam emitter the window temperature rises by 200° C. or more. During this temperature rise the copper expands; the previously-stretched titanium foil unfolds at its wrinkles to accommodate the extra area required by the hot copper. When cooled, the copper returns to its original size and wrinkles form again in the titanium foil. Cycles of heating (unfolding wrinkles) and cooling (refolding wrinkles) can fatigue the thin film window and cause mechanical failure to occur. This mechanical failure can take the form of splits or holes in the foil, and results in loss of vacuum, rendering the device inoperable. Mechanical failure results in loss of vacuum in the device, leaving it inoperable.

The systems and methods described herein reduce likelihood of deformations forming wrinkles that create points of mechanical failure. These systems and methods will now be described with reference to an electron emitter device. However, it will be apparent to those of skill in the art that the systems and methods described herein apply equally to other kinds of similar vacuum chamber devices, such as electron emitter devices of other geometries and sizes, x-ray devices, ion beam devices, and other similar devices.

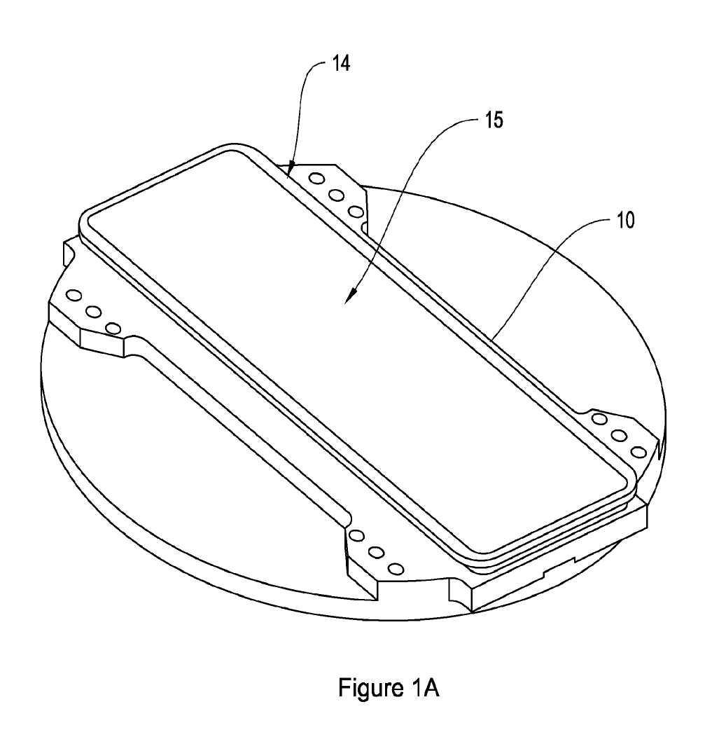

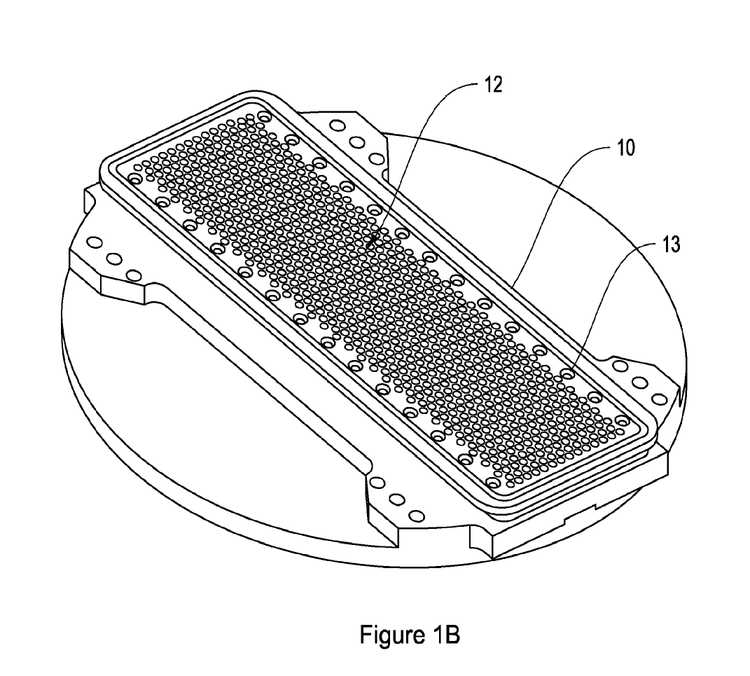

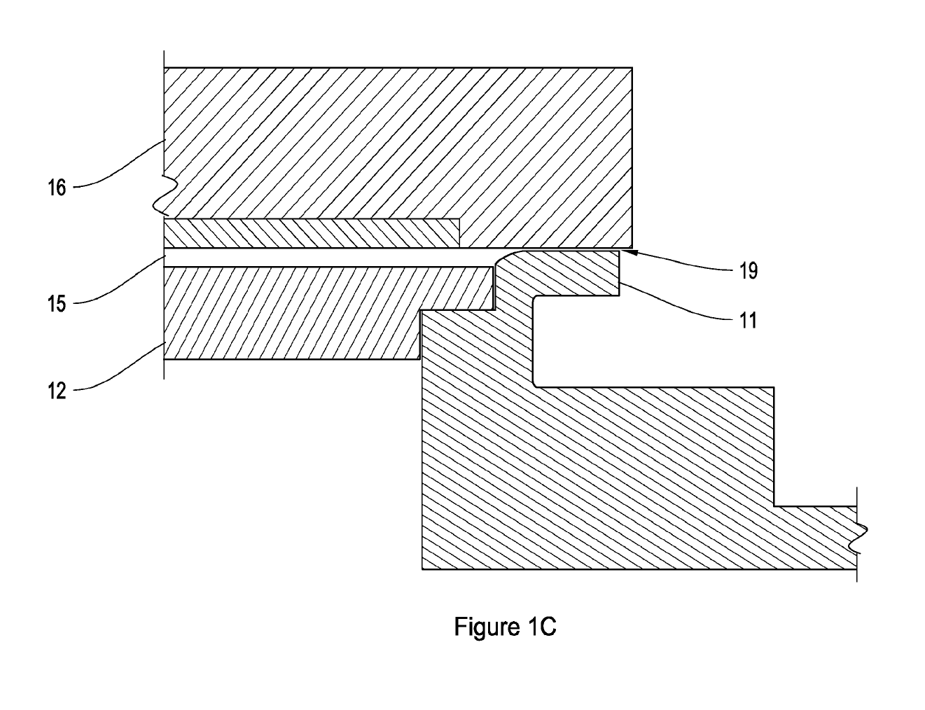

FIGS. 1A and 1B depict the exit window structure 10 of an electron emitter device. FIGS. 1A and 1B show an example vacuum window structure consisting of a support base and a support grid. Mounting holes used to secure the grid to the base with screws or bolts are shown in the support grid. The transmission layer covers the entire support grid and overlaps the edge of the support base. FIG. 1A depicts the electron emitter exit window 10 with the thin foil 15 bonded to the emitter exit window 10 at the peripheral edge 14 of the exit window 10. As can be seen in FIG. 1A the foil 15 extends across substantially the entire surface of the exit window 10 and provides a transmissive layer that will allow electrons to pass from the vacuum chamber (not shown) while at the same time providing a seal that allows the vacuum chamber to maintain a hermetic seal. FIG. 1B depicts the exit window 10 with the foil 15 removed. Beneath the foil 15 is the support grid 12 that includes a plurality of apertures that allow electrons to pass through the exit window 10 and the transmissive film 15 (not shown in FIG. 1B). As can be seen in FIG. 1B the support grid includes apertures 12 and other features such as the recess 13 that provide a support structure that has an upper surface, which is shown in FIG. 1B, that can support the film 15, depicted in FIG. 1A.

FIG. 1C shows how the foil transmissive layer 15 may be bonded to the perimeter of the supporting base 11 with the support grid 19 positioned so as to support the foil transmission layer 15. A clamp 16 is used to apply uniform pressure to the perimeter of the transmission layer-support grid structure at the bond surface during a diffusion bonding process, or other process for joining the foil transmissive layer 15 to the support grid.

As discussed above, the bonding process can cause thermal expansion both in the support grid and in the foil transmissive layer 15. Given differences in material characteristics between the material that makes up the foil transmissive layer 15 and the material that makes up the support grid 12, differences in the surface area of the foil transmissive layer 15 and the surface area of the support grid 12 can arise, resulting in the wrinkles, folds and other surface abnormalities being formed in the foil transmissive layer 15.

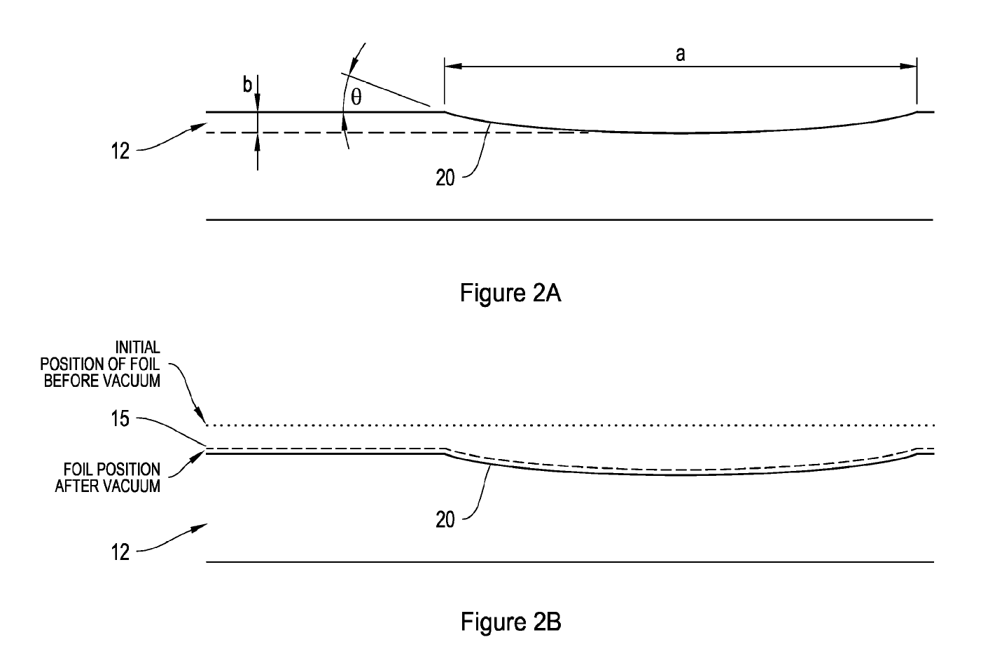

FIGS. 2A and 2B depict in more detail the upper surface of the support grid 12 having contours for providing a support surface having sufficient area to take up and support the additional surface area of the foil transmissive layer 15 that is created after thermal expansion. Particularly, FIG. 2A depicts the upper surface of the support grid 12 and shows a contour 20 formed in the upper surface and providing a gradually receding plane that increases the overall grid 12. As shown in FIG. 2A the recessed contour has a width 2a, a depth 2b and an angle of approach 2c. The size of the surface area of the contour 20 may be selected to increase the surface area of the support grid 12 by an amount comparable to the expected increase in the surface area of the foil transmissive layer 15. In one embodiment, the increase in surface area is determined by considering the general difference in the changes of length between the two materials being heated, that is the material of the transmissive layer 15 and the material of the support grid 12. Typically, the expansion occurs both in the horizontal direction and in the vertical direction and thus the change in overall surface area can be determined by looking at the change in length.

In general, the difference in length between the two heated materials, ΔL, is expressed:

ΔL=L·(α1−α2)·ΔT

Where L is the initial material dimension, α1 is the linear coefficient of thermal expansion for the expanding (transmission) layer, α2 is the linear coefficient of thermal expansion for the elastic (support) layer, an example vacuum window construction using a titanium foil transmission layer and a copper support grid, L is approximately 250 mm in the long dimension and 75 mm in the short dimension. This results in ΔL_{long}≅1 mm and {Lₛₕₒᵣₜ≅0.3 mm.

Some common materials for transmission layers and support, grids and their hulk linear coefficients of thermal expansion, at room temperature (293K) are shown in the table below.

| Transmission Layer | | Support Grid | |
|---|---|---|---|
| | α | | α |
| | μm/m · K @ | | μm/m · K @ |
| Material | 293 K | Material | 293 K |
| Titanium | 9 | Cpper | 16 |
| Aluminum | 24 | 300-series stainless steel | 18 |
| | | | (average) |
| Beryllium | 12 | 400-series stainless steel | 12 |
| | | | (average) |
| Nickel | 13 | Gold | 14 |
| Diamond | 2 | Platinum | 9 |
| | (average) | | |

Contours are added to the perimeter and body of the support grid structure that supports the foil electron transmission layer 15. These contours increase the surface area of the support grid 12 providing extra surface area that can accommodate the extra surface area of foil transmission layer 15 material that, forms during a diffusion bonding process. The shape of the contour can be controlled so as to minimize the number and severity of stress points created in the foil transmission layer 15. As shown in FIG. 2B, when the support structure cools and contracts in size, the extra surface areas of the enlarged transmissive layer can lay flat against the smooth, optionally finished, surface of the contour recess, pulled flat and held in place by the vacuum in the chamber. In one embodiment, the contours are formed by a manufacturing process that:

1. constructs a support grid with a surface area that matches or is just slightly less than the surface area of the transmission layer after it is has expanded during the diffusion bonding process,

2. reduces to substantially minimize the reduction in support grid mass to maintain high to maximal thermal conductivity,

3. uses contour shapes that allow expanded transmission layer material to expand in such away so as to minimize stress points.

As shown in FIG. 2a, support grid contour design may vary certain parameters of the contour, such as for example, the width of the contour (2a), the depth of the contour (2b) and the approach angle (2c). Variation of these and other parameters allow for forming a contoured recess that provides a gradual recession into the upper surface of the support 12. The rate of decrease may be selected to avoid surface features, such as ridges or valleys, and more typically to avoid abrupt topological changes, such as edges. The rate of decrease may, in one practice, be selected as a function of the mechanical characteristics of the foil, such as its elasticity, to select features that would avoid causing inelastic changes to the shape of the foil. Typically, this would avoid edges that may form wrinkles as the foil is pulled by the vacuum against the contour 20. Other parameters may be varied and the parameters varied will depend upon the Application at hand,

Support grid contours can be categorized as being edge contours and body contours. Edge contours are positioned on the edge or perimeter of the support grid. Edge contours control the shape (sharpness) and initiation location of the wrinkles. Wrinkles typically occur between the site of the diffusion bond—the place where the thin film is pinned to the substrate—and the unpinned, free-moving thin film material. The contoured features in the edge of the support structure near the bond have width, depth, location and optionally finish, and force the wrinkles to land in well defined patterns without sharp edges or changes in direction.

To minimize the formation of large wrinkles in the middle of the window, where the large area of extra thin film is present, large body contours may be added to the support grid 12, which provide additional surface area for the extra thin film or foil to cover. These large contours increase the net surface area, of the support, grid 12 and accommodate the extra, film without wrinkles. Varieties of shapes are possible and were investigated for the resulting foil wrinkles. The size, location, shape and depth of the contours is determined by the types of materials, their coefficients of thermal expansion, the process temperature and the size and shape of the diffusion bonded region.

As an alternative to providing large contours to the body of the support, grid, large slots can be used. These large slots enable the extra foil area to fall in unsupported grid space and prevent wrinkles from forming.

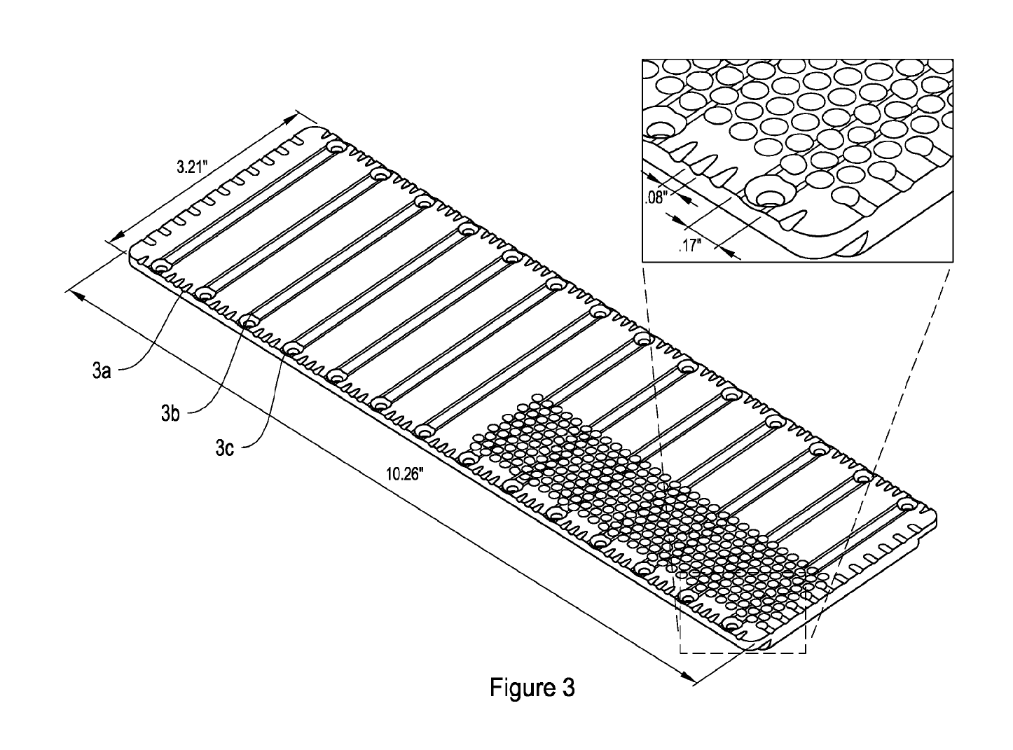

FIGS. 3-12 illustrate alternative embodiments of support structures having recessed contoured surfaces. These embodiments are provided for the purpose of illustration only and are not la be deemed as limiting in any way.

FIG. 3 illustrates an example support, grid that includes edge contours consisting of small angled grooves (3a) and body contours in the form of wide grooves (3b) parallel to the short axis of the support grid aligned with the mounting holes (3c). For clarity, the grid apertures are shown on just a portion of the diagram. Typically, apertures are arrayed across the entire topology. As shown in the close up section of FIG. 3, the recessed contours provide a recessed surface at one side of the mounting hole and has a width of about 0.17 inches or about 0.43 centimeters. These contours are body contours that extend from mounting hole to mounting hole. The depicted support also has evenly spaced edge contours between the mounting holes. These depicted contours are edge contours and about 0.08 inches or 0.25 centimeters wide,

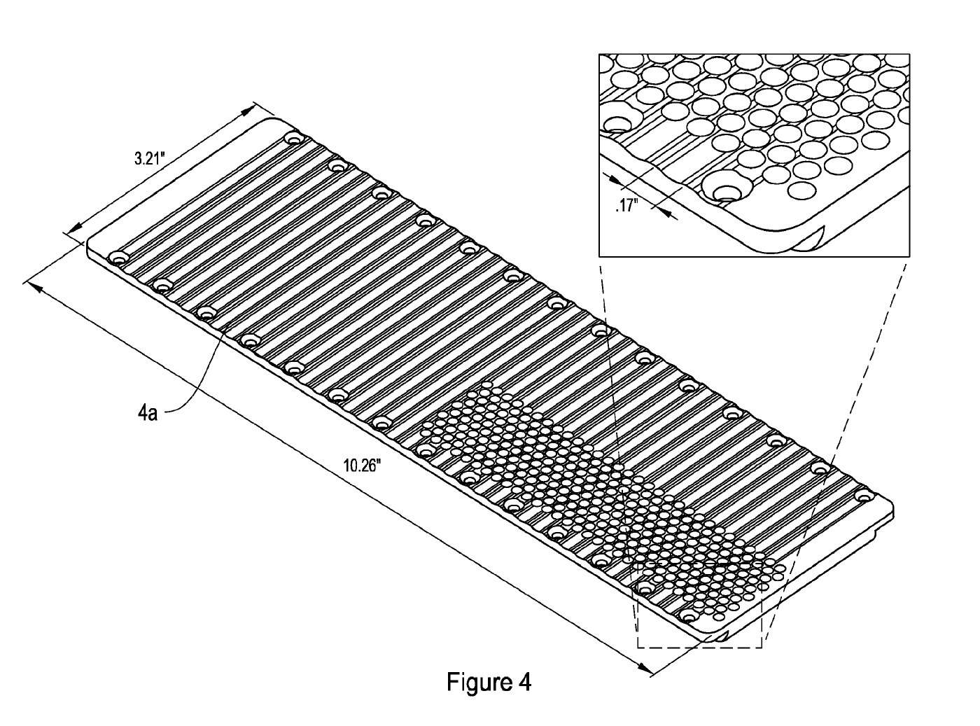

FIG. 4 illustrates an example support grid that has multiple wide grooves (4a) oriented parallel to the short axis of the support grid. These wide grooves extend to the edge of the support grid and serve as both edge and body contours. For clarity, the grid apertures are shown on just a portion of the diagram. Apertures are arrayed across the entire topology.

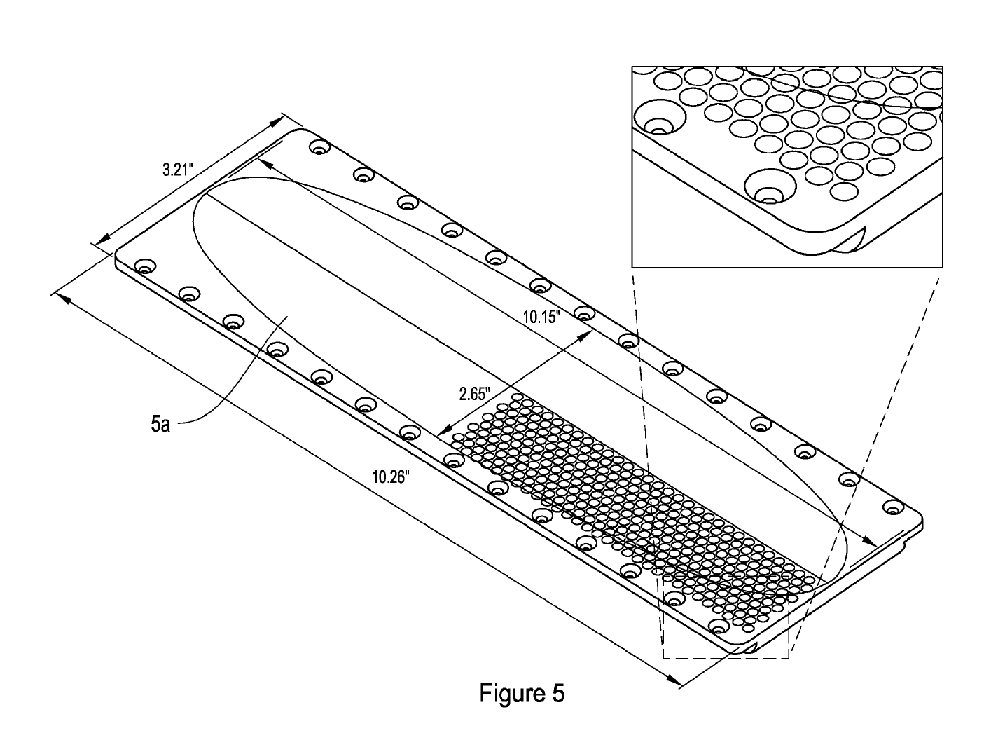

FIG. 5 illustrates an example support grid that has no edge contours and has a single body contour consisting of a swept ellipsoid depression of varying depth (5a). For clarity, the grid apertures are shown on just a portion of the diagram. Apertures are arrayed across the entire topology.

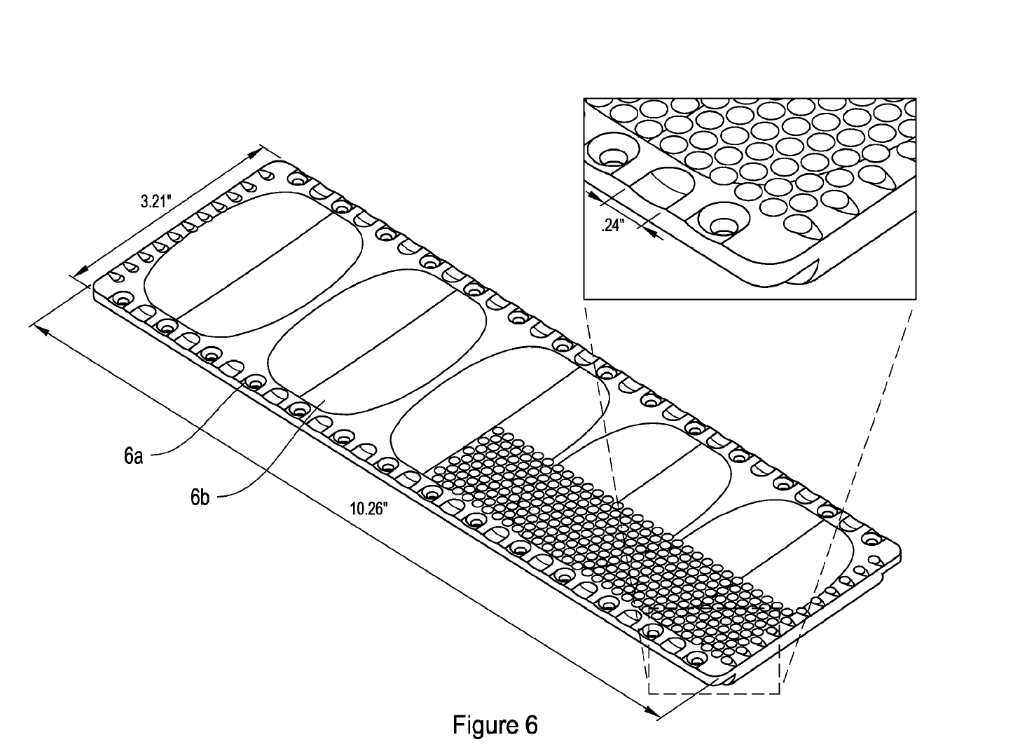

FIG. 6 illustrates an example support grid that has edge contours consisting of partial spheroids (6a) and body contours consisting of ellipsoid depressions (6b) oriented such that the short axis of the contour runs parallel to the long axis of the support grid. Multiple ellipsoid contours run along the long axis of the support grid. The radius of the partial spheroids may vary. For clarity, the grid apertures are shown on just a portion of the diagram. Apertures are arrayed across the entire topology,

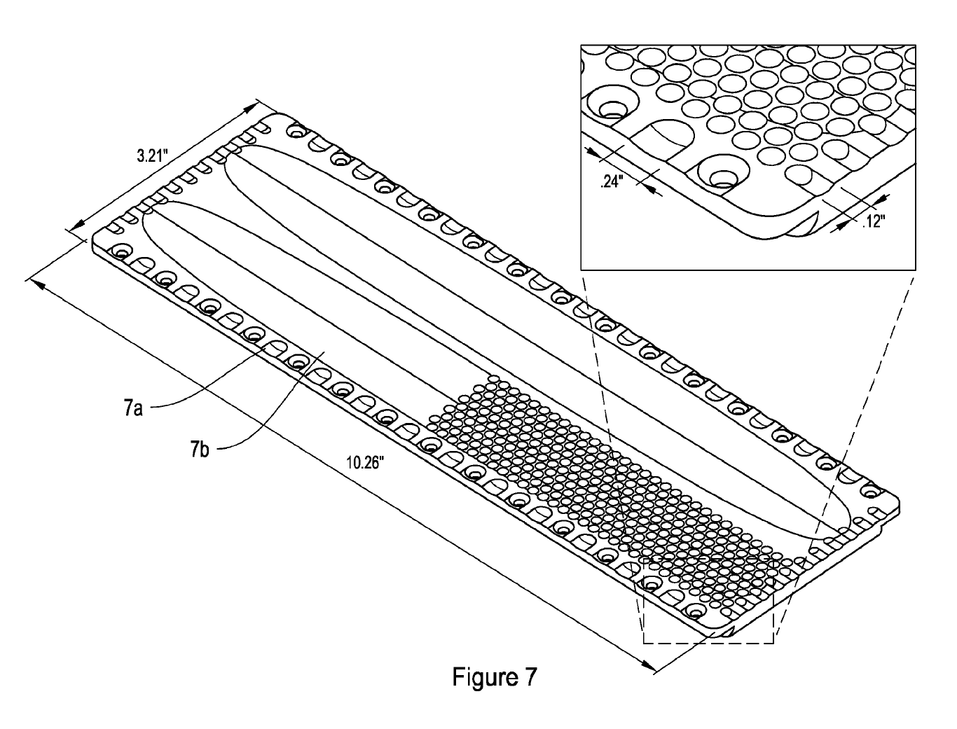

FIG. 7 illustrates an example support, grid that has edge contours consisting of partial spheroids (7a) and body contours consisting of ellipsoid depressions (7b) oriented such that the short axis of the contour rims parallel to the short axis of the support grid. Multiple ellipsoid contours run along the short axis of the support, grid. The radius of the partial spheroids may vary. For clarity, the grid apertures are shown on just a portion of the diagram. Apertures are arrayed across the entire topology.

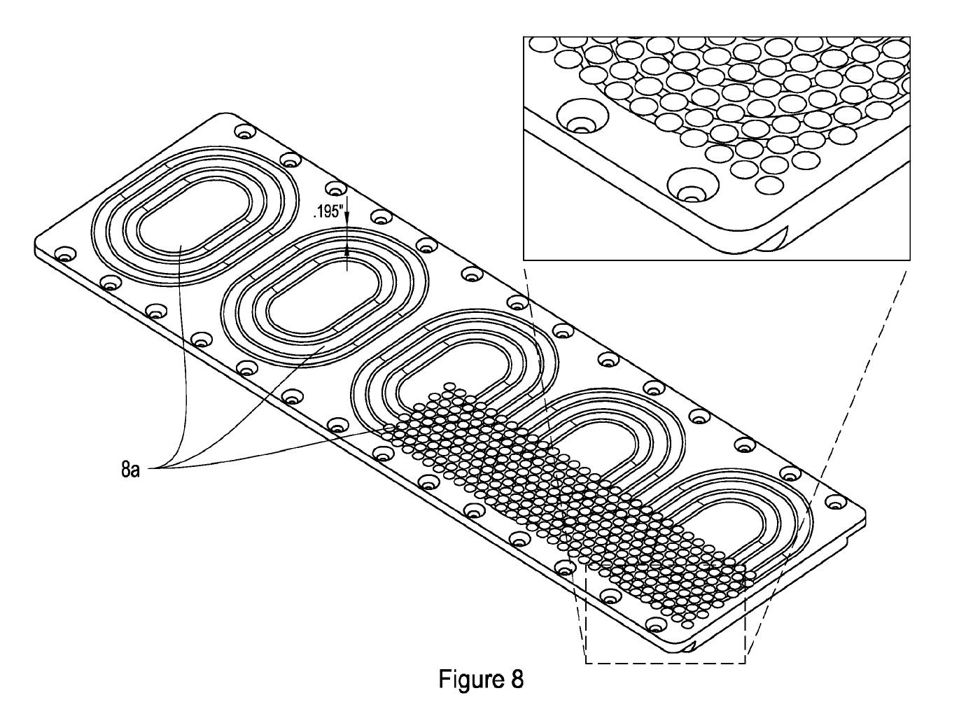

FIG. 8 illustrates an example support grid that has no edge contours and has body contours consisting of continuous grooves oriented in concentric rings (8a). Multiple sets of concentric rings may be oriented along the long axis of the support grid. For clarity, the grid apertures are shown on just a portion of the diagram. Apertures are arrayed across the entire topology.

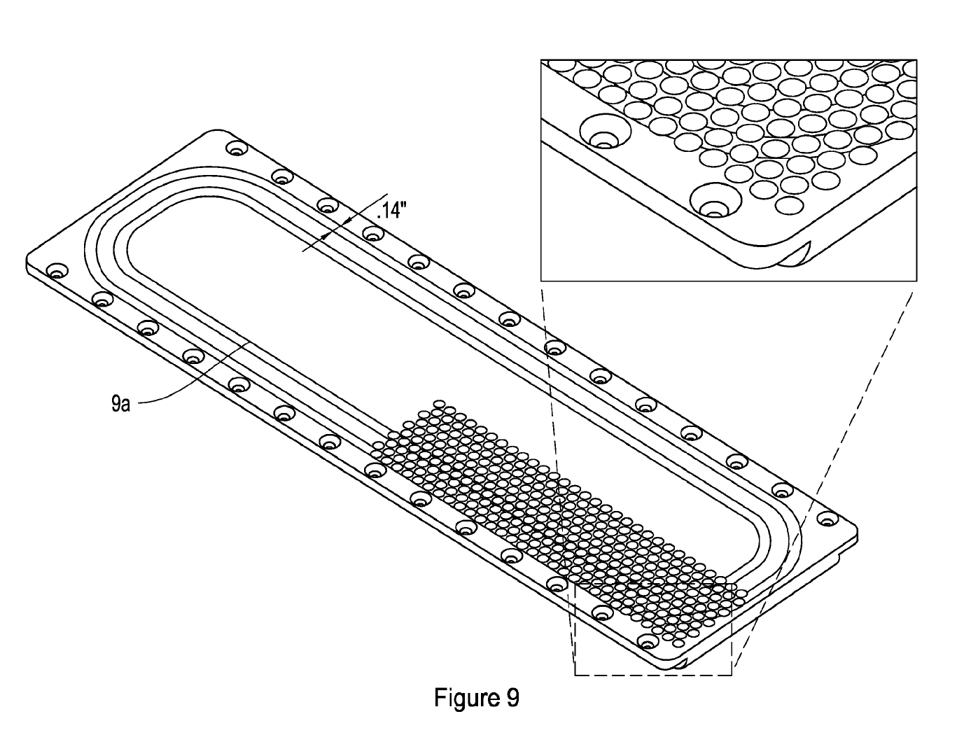

FIG. 9 illustrates an example support grid that has no edge contours and has body contours consisting of a single set of continuous grooves oriented in concentric rings (9a) with the long axis of the rings running parallel to the long axis of the support grid. For clarity, the grid apertures are shown on just a portion of the diagram. Apertures are arrayed across the entire topology.

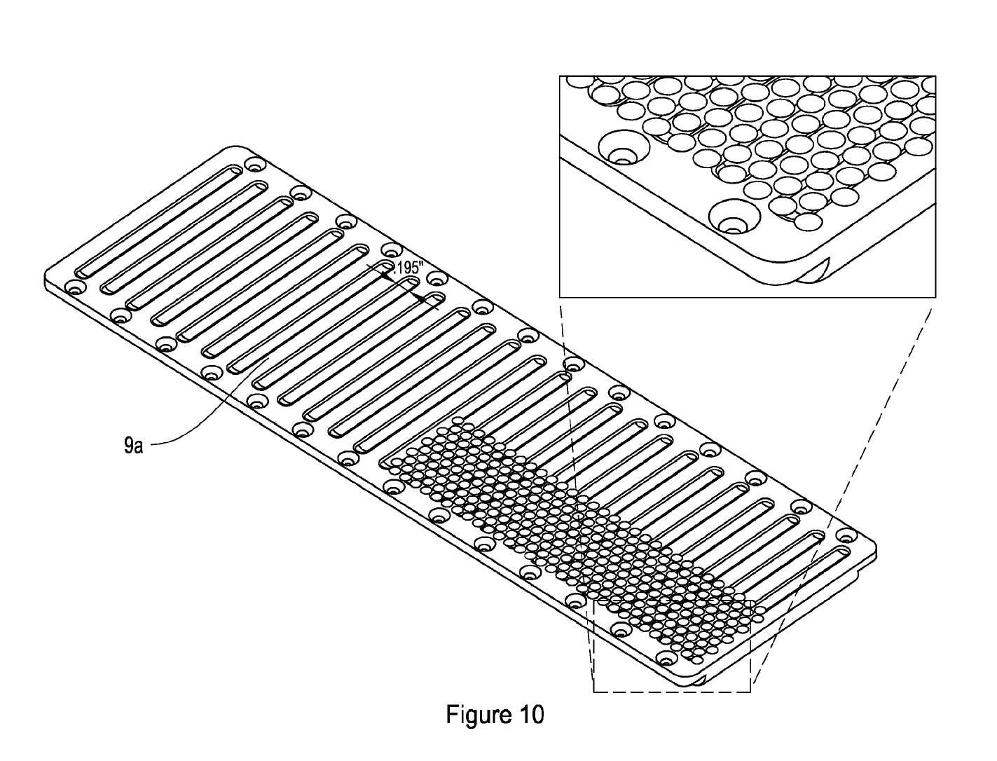

FIG. 10 illustrates an example support grid that has no edge contours and had body contours consisting of multiple continuous grooves (10a) oriented with the long axis of the groove parallel to the short axis of the support grid. For clarity, the grid apertures are shown on just a portion of the diagram. Apertures are arrayed across the entire topology.

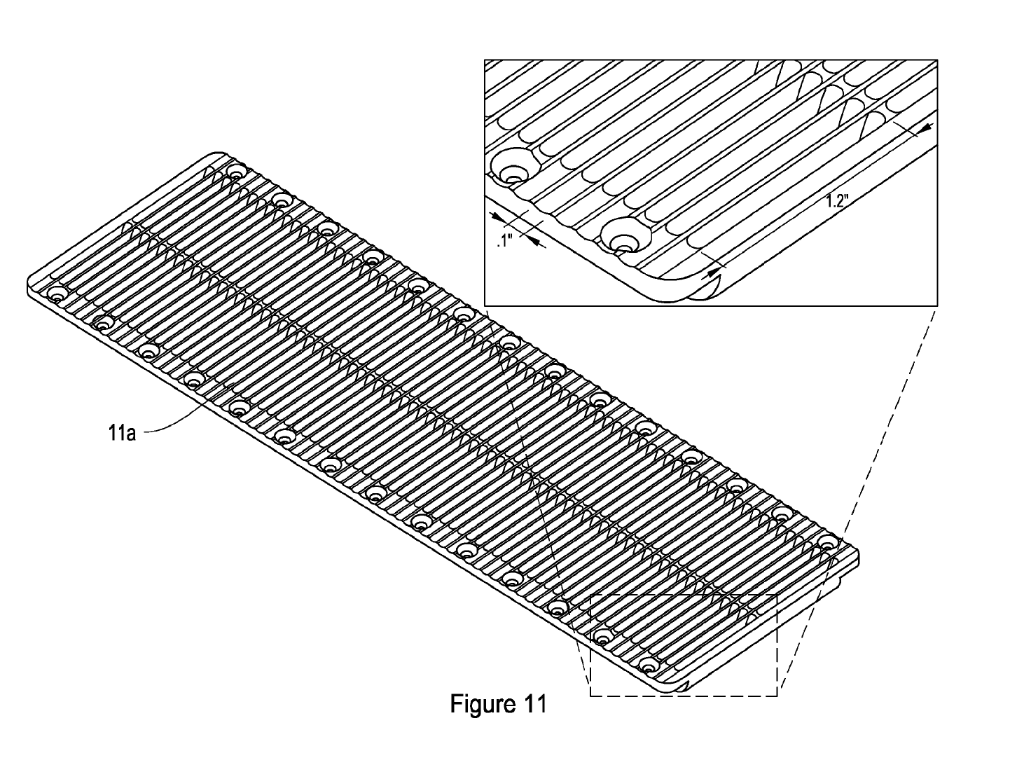

FIG. 11 illustrates an example support grid that has narrow grooves oriented parallel to the short axis of the support grid. Grooves are aligned with slots that are also oriented parallel to the short axis of the support grid. These narrow grooves extend to the edge of the support grid and serve as both edge and body contours.

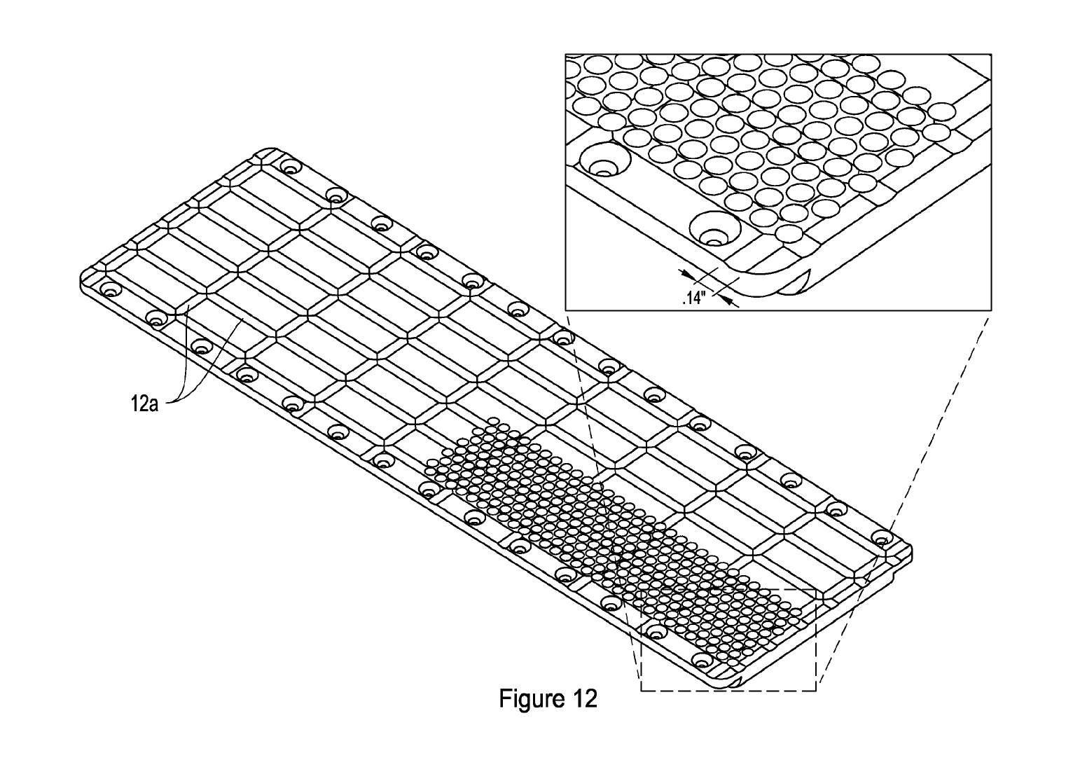

FIG. 12 illustrates an example support grid that has contours consisting of intersecting grooves running perpendicular to each other. For clarity, the grid apertures are shown on just a portion of the diagram.

Those skilled in the art will know or be able to ascertain using no more than routine experimentation, many equivalents to the embodiments and practices described herein. For example, the shape, size and materials of the support grid, transmissive layer and other materials may vary as appropriate for the application. Additionally, the systems described herein may be used with other supported foil devices, such as x-ray emitters. It will also be understood that the systems described herein provide advantages over the prior art including improved reliability.

Accordingly, it will be understood that the invention is not to be limited to the embodiments disclosed herein, but is to be understood from the following claims, which are to be interpreted as broadly as allowed under the law.

What is claimed is:

1. An exit window for an emitter comprising:
a support plate having a series of apertures for allowing passage of a beam there through; and
an exit window foil bonded over the support plate, the support, plate having a planar surface and at least one surface recess which allows portions of the exit window foil to rest within the recess to reduce wrinkle formation.

2. The exit window of claim 1 wherein the support plate has a first pattern of surface recesses.

3. The exit, window of claim 2 wherein the first pattern of surface recesses extend in a lateral direction relative to the support plate.

4. The exit window of claim 2 wherein the first pattern of surface recesses are in central regions of the support plate, and a second pattern of surface recesses are in edge regions.

5. The exit window of claim 2 wherein the first pattern of surface recesses extends in a longitudinal direction relative to the support plate.

6. The exit window of claim 1 wherein the at least one surface recess extends in a longitudinal direction relative to the support plate.

7. The exit window of claim 1 wherein the at least one surface recess includes at least one groove.

8. A process for manufacturing a support plate for an exit window having a foil transmissive layer, comprising
providing a support grid of a first material having a first coefficient of thermal expansion;
providing a layer of transmissive material the layer having a length, a width and an initial surface area, covering the support grid to form a seal over the grid, the layer of transmissive material having a second different coefficient of thermal expansion,
determining as a function of at least the first and second coefficients of thermal expansion, an expanded surface area represented of a surface area of the transmissive layer after a thermal expansion; and
forming a contour Is the support grid to provide the support grid with a surface area on its upper surface comparable to the expanded surface area.

9. The process of claim 8, further comprising determining the expanded surface area as a function of thermal expansion arising from a thermal increased caused by a diffusion bonding operation.

10. The process of claim 8, further comprising locating an expansion initiation point on the layer of transmissive material representative of a location at which a thermal expansion process commences.

11. The process of claim 10, wherein locating includes identifying a location proximate a boundary between a joint between the support grid and layer of transmissive material and a free section of the layer of transmissive material.

12. The process of claim 8, further comprising selecting a surface finish for the contour.

13. The process of claim 8, further comprising placing a plurality of substantially evenly spaced contours across an upper surface of the support grid.
